(19) United States
(12) Patent Application Publication
(10) Pub. No.: US 2009/0255268 A1
(43) Pub. Date: Oct. 15, 2009

(54) Divergent cooling thimbles for combustor liners and related method

(75) Inventors: Karthick Kaleeswaran, Bangalore Karnataka (IN); Ganesh Pejawar Rao, Bangalore Karnataka (IN)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 12/081,167

(22) Filed: Apr. 11, 2008

(51) Int. Cl. F02C 1/00

(52) U.S. Cl. 60/757

(57) ABSTRACT

A cooling arrangement for a turbine combustor liner includes a combustor liner; a flow sleeve surrounding at least a portion of the combustor liner with a flow annulus therebetween, the flow sleeve having a plurality of rows of cooling holes formed about a circumference thereof for directing cooling air into the flow annulus and toward the combustor liner. One or more of the cooling holes is fitted with a thimble extending in a radial direction toward the combustor liner, the thimble having a peripheral wall diverging in a direction of flow of the cooling air.

### BACKGROUND OF THE INVENTION

This invention relates generally to turbo machinery and specifically, to the cooling of combustor liners in gas turbine combustors.

Conventional gas turbine combustion systems employ multiple combustor assemblies to achieve reliable and efficient turbine operation. Each combustor assembly includes a cylindrical liner, a fuel injection system, and a transition piece that guides the flow of the hot gases from the combustor to the inlet of the turbine. Generally, a portion of the compressor discharge air is used to cool the combustor liner and is then introduced into the combustor reaction zone to be mixed with the fuel and burned.

In systems incorporating impingement cooled transition pieces, a hollow sleeve (also referred to herein as “transition sleeve”) surrounds the transition piece, and the sleeve wall is perforated so that compressor discharge air will flow through the cooling apertures in the sleeve wall and impinge upon (and thus cool) the transition piece. This cooling air then flows along an annulus between the sleeve and the transition piece. This so-called “cross flow” eventually flows into another annulus between the combustor liner and a surrounding flow sleeve (also referred to herein as a “liner sleeve”). The liner sleeve is also formed with several rows of cooling holes about its circumference, the first row located adjacent a mounting flange where the liner sleeve joins to the transition sleeve.

Even though there is a strong crossflow resulting from the transition piece cooling flow, the negative impact of the crossflow on the impingement cooling flow may be minimized by the use of collars or cooling conduits, also referred to as “thimbles”, that are inserted into the cooling holes in the combustor liner sleeve, through which the cooling jets pass. These thimbles provide a physical blockage to the cross flow which forces the crossflow into the desired flow path while simultaneously ensuring that the cooling jets effectively impinge on the combustor liner surface to be cooled.

The thimbles or collars are preferably mounted in each hole of at least the first row of holes at the aft end of the liner sleeve, adjacent a mounting flange where the combustor liner and transition piece are joined. This arrangement decreases the gap between the jet orifices and impingement surface; blocks the cross flow that deflects the jets and forces the cross flow into the desired flowpath for the subsequent jet rows; allows the diameter of the jets to be smaller and thereby reduce cooling air; and provides consistent and accurate control over the location of jet impingement. It also stabilizes unwanted axial oscillation of the first row of jets and prevents the formation of a thick boundary layer (and resulting reduced heat transfer) upstream of the first row of jets. The use of thimbles as described above is disclosed in commonly-owned U.S. Pat. No. 6,484,505.

There remains a need, however, for even more effective impingement cooling of combustor liners by cooling jets directed at the liner surface, but without creating high thermal gradients along the liner.

### BRIEF DESCRIPTION OF THE INVENTION

In one exemplary but non-limiting embodiment, the thimble geometry is altered so that the walls of the thimble diverge in a direction from the thimble inlet to the thimble outlet. In other words, the thimbles have a truncated-cone shape, such that the cooling jets spread radially outwardly as they flow towards the combustor liner, thus providing more uniform cooling of the aft section of the liner.

Accordingly, in one aspect, the invention relates to a cooling arrangement for a turbine combustor liner comprising: a combustor liner; a flow sleeve surrounding at least a portion of the combustor liner with a flow annulus therebetween, the flow sleeve having a plurality of rows of cooling holes formed about a circumference thereof for directing cooling air into the flow annulus and toward the combustor liner; wherein at least one thimble is fitted within a respective one or more of the cooling holes, the at least one thimble extending in a radial direction toward the combustor liner, and having a peripheral wall diverging in a direction of flow of the cooling air.

In another aspect, the invention relates to A method of cooling a combustor liner surrounded by a flow sleeve comprising: forming plural cooling holes in the flow sleeve; and fitting thimbles in at least some of the cooling holes, each of the thimbles having a diverging peripheral wall in the direction of flow of cooling fluid through the thimbles toward the combustor liner.

The invention will now be described in connection with the figures identified below.

### BRIEF DESCRIPTION OF THE DRAWINGS

FIG. 1 is a simplified side cross section of a conventional combustor transition piece aft of the combustor liner;

FIG. 2 is a partial but more detailed perspective of a conventional combustor liner and liner flow sleeve joined to the transition piece;

FIG. 3 is a flow diagram illustrating impingement cooling of the combustor liner in a prior arrangement;

FIG. 4 is a partial perspective view illustrating impingement cooling with divergent thimbles in accordance with an exemplary but non-limiting embodiment of the invention; and

FIG. 5 is an enlarged detail taken from FIG. 4.

### DETAILED DESCRIPTION OF THE INVENTION

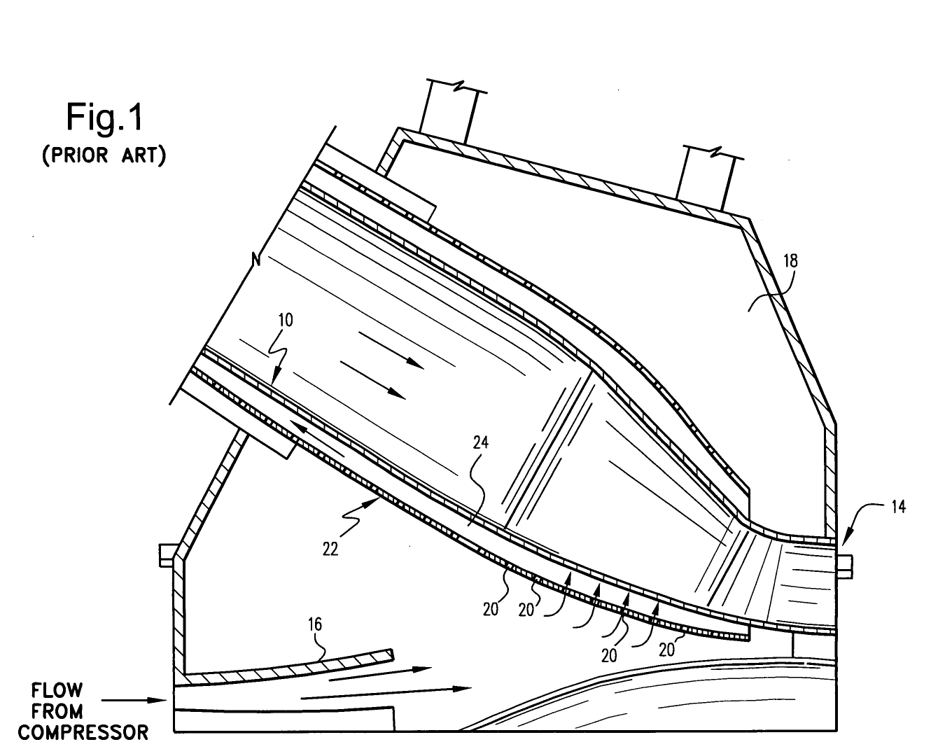

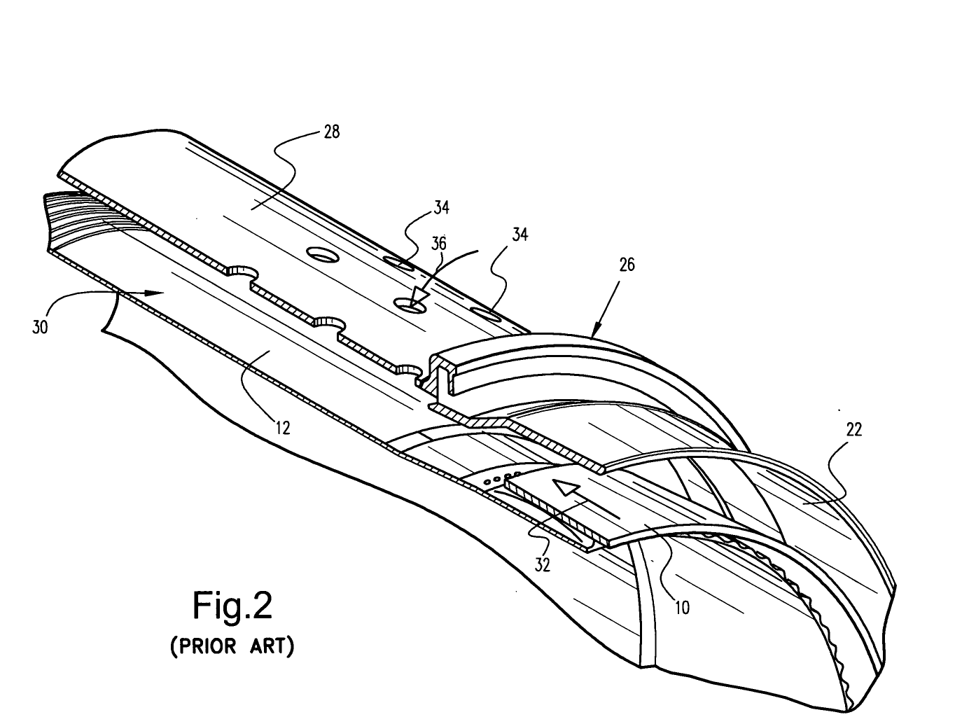

With reference to FIGS. 1 and 2, a typical gas turbine includes a transition piece 10 by which the hot combustion gases from an upstream combustor as represented by the combustor liner 12 (FIG. 2) are passed to the first stage of a multi-stage turbine component represented at 14.

Flow from the gas turbine compressor exits an axial diffuser 16 and enters into a compressor discharge case 18. About 50% of the compressor discharge air passes through apertures 20 formed along and about a transition piece impingement sleeve 22 for flow in an annular region or annulus 24 between the transition piece 10 and the radially outer transition piece impingement sleeve 22. The remaining approximately 50% of the compressor discharge flow passes into flow sleeve holes 34 and mixes with the air from the transition piece from annulus 30 and eventually mixes with the gas turbine fuel in the combustor.

FIG. 2 illustrates the connection between the transition piece 10 and the combustor line flow sleeve 28 as it would appear at the far left hand side of FIG. 1. Specifically, the impingement sleeve 22 of the transition piece 10 is received in a telescoping relationship in a mounting flange 26 on the aft end of the combustor flow sleeve 28, and the transition piece 10 also receives the combustor liner 12 in a telescoping relationship. The combustor flow sleeve 28 surrounds the combustor liner 12 creating a flow annulus 30 therebetween.

It can be seen from the flow arrow 32 in FIG. 2, that crossflow cooling air traveling in the annulus 24 continues to flow into the annulus 30 in a direction perpendicular to impingement cooling air flowing through the cooling holes 34 (see flow arrow 36) formed about the circumference of the liner sleeve 28 (while three rows are shown in FIG. 2, the liner sleeve may have any number of rows of such holes).

The impingement cooling flow in the first row of holes 34 in the liner sleeve (the row of holes closest to the mounting flange 26) is particularly subject to disruption by the crossflow from the annulus 24. The cross flow impacts on the first row cooling jets exiting the holes 34, bending them over and degrading their ability to impinge upon the liner 12. Depending on the relative strengths of the cross flow and jets, the jet flow may not even reach the surface of the combustor liner 12. Because the impingement jets are high velocity, there is a characteristic zone of low static pressure behind the jets and near the liner sleeve entrance holes. The cross flow accelerates toward the low pressure zone, leading to a velocity gradient across the liner sleeve/liner annulus 30. The resulting low velocity and thickened boundary layer near the liner surface has very poor heat transfer effectiveness.

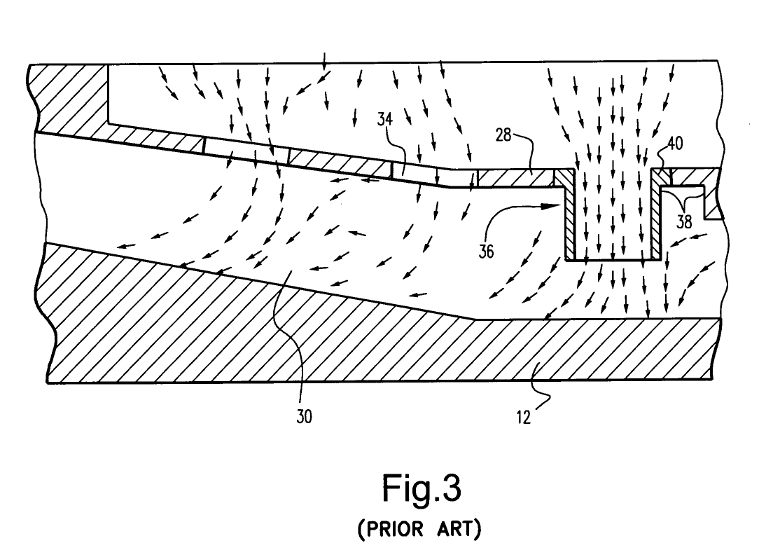

To neutralize the negative impact of the crossflow on the cooling jets, cooling thimbles 36 as shown in FIG. 3 have been employed. These thimbles comprise tubes 38 of circular cross section, with a flat ring or flange 40 welded to (or formed with) its top. The tube or body portion 38 of each thimble 36 was formed of a uniform diameter. The cooling flow from the compressor discharge entered the transition piece annulus and then flowed into the thimbles. The thimbles focused the cooling jets onto the hot spots in the liner, resulting in a strong impingement cooling action. This impingement action, however, leads to high thermal gradients along the circumference of the liner.

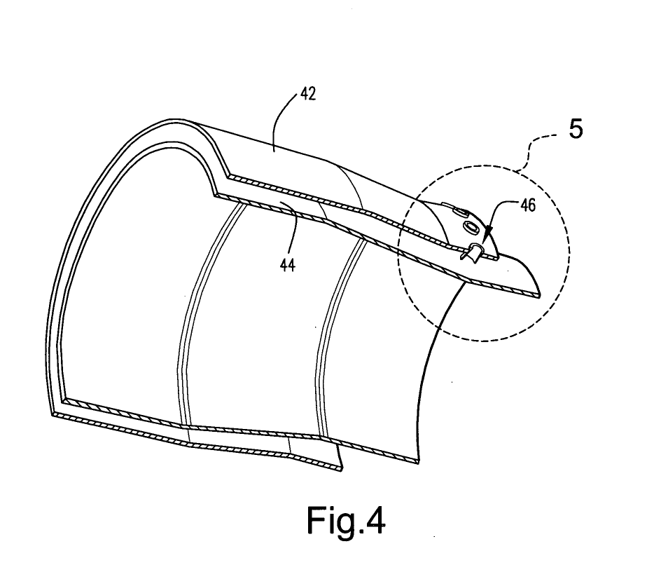

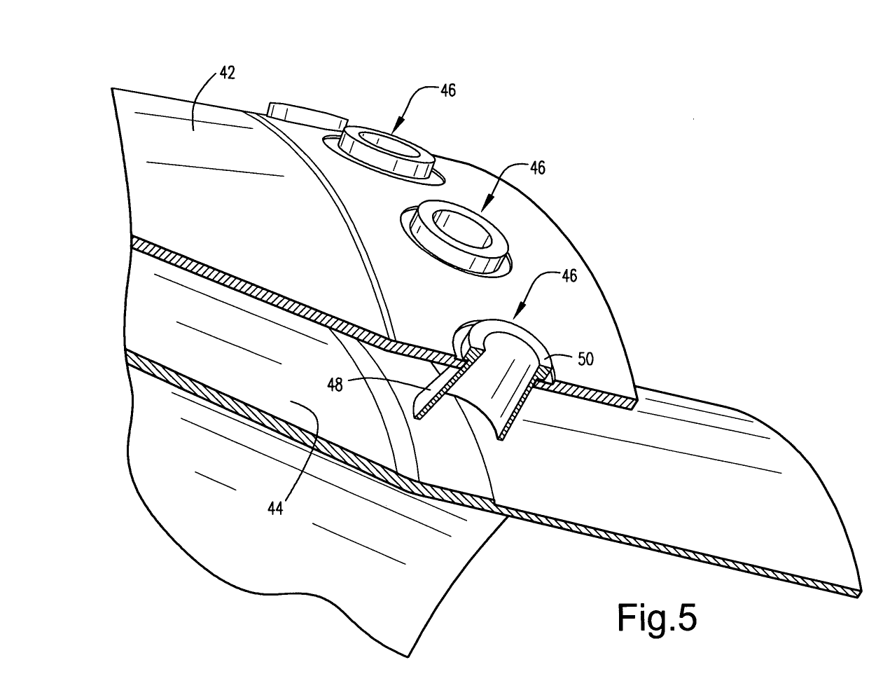

In accordance with an exemplary but non-limiting implementation of this invention, and with reference to FIGS. 4 and 5, a combustor liner flow sleeve 42, surrounding a combustor liner 44, is fitted with modified thimbles 46, each of which has a peripheral wall 48 that diverges in the direction of flow so that the cooling jets expand as they flow towards the surface of the liner 44. The dimensions of the thimbles 46 are set by the liner/flow sleeve gap, the tolerance of this dimension, the jet and cross flow momentum, the geometric constraints of the thimble, and the specific cooling requirements of the particular turbine. Preferred relationships, however, include range of minimum to maximum diameter of the diverging wall of from 1.2D to 2D, where D is the base diameter of the peripheral wall. The angle of divergence may be any angle up to about 30 degrees. The thimbles 46 may be made of the same material as the flow sleeve 42. One or more thimbles 46 may be located in one or more rows (staggered or in line) of axially spaced cooling holes, but not necessarily in every hole of each row. Some rows could have diverging thimbles 46 only, while other rows might have all straight thimbles 36, while still other rows might have a combination of the two types of thimbles. In all cases, the thimbles are preferably welded at the ring or flange 40 or 50 to the outside of the liner sleeve 28 or 42, respectively.

The cross section of the tubular peripheral wall 48 is shown to be circular but other cross-sectional shapes could be used, e.g., square, triangular, airfoil-shaped, semi-circular and the like, so long as there is divergence in the flow direction. The divergent or expanding thimble design cools the aft section of the liner effectively by directing and spreading the jet towards the liner in a manner that does not produce meaningful thermal gradients along the liner, and thus produces more uniform cooling of the aft section of the liner.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A cooling arrangement for a turbine combustor liner comprising:
a combustor liner;
a flow sleeve surrounding at least a portion of said combustor liner with a flow annulus therebetween, said flow sleeve having a plurality of rows of cooling holes formed about a circumference thereof for directing cooling air into said flow annulus and toward said combustor liner;
wherein at least one thimble is fitted within a respective one or more of said cooling holes, said at least one thimble extending in a radial direction toward said combustor liner, and having a peripheral wall diverging in a direction of flow of the cooling air.

2. The arrangement of claim 1 wherein said at least one thimble is tubular in shape, with a radial flange at one end thereof.

3. The arrangement of claim 2 wherein said at least one thimble is welded to said flow sleeve, with an opposite end of said tube radially spaced from said liner by a predetermined amount.

4. The arrangement of claim 2 wherein said at least one thimble is circular in cross-section.

5. The arrangement of claim 1 wherein said at least one thimble comprises plural thimbles in a row of cooling holes spaced about a circumference of said liner.

6. The arrangement of claim 1 wherein said at least one thimble diverges uniformly from one end to another at a divergence angle of up to about 30°.

7. The arrangement of claim 5 wherein said plural cooling thimbles are located at an aft end of said flow sleeve.

8. The arrangement of claim 2 wherein said radial flange is seated on an outside peripheral surface of the flow sleeve.

9. The arrangement of claim 1 wherein said at least one thimble includes a tube with a radial flange at one end thereof, said radial flange seated on an outside peripheral surface of the flow sleeve.

10. A method of cooling a combustor liner surrounded by a flow sleeve comprising:
a. forming plural cooling holes in said flow sleeve; and
b. fitting thimbles in at least some of said cooling holes, each of said thimbles having a diverging peripheral wall in the direction of flow of cooling fluid through said thimbles toward said combustor liner.

11. The method of claim 10 wherein each of said thimbles is tubular in shape, with a radial flange at one end thereof.

12. The method of claim 10 wherein step b. is carried out by welding said thimbles to said flow sleeve.

13. The method of claim 10 wherein said diverging peripheral wall is circular in cross section.

14. The method of claim 10 wherein step a. includes forming plural rows of cooling holes and step b. includes fitting thimbles in at least some cooling holes of each row.

15. The method of claim 10 wherein each of said thimbles diverges uniformly from one end to another at a divergence angle of about 30°.

16. The method of claim 14 wherein at least some of said thimbles are located at an aft end of said flow sleeve.

17. The method of claim 11 wherein step b. is carried out by seating said radial flange on an outside peripheral surface of said flow sleeve.
